(19) United States
(12) Patent Application Publication
(10) Pub. No.: US 2012/0286929 A1
(43) Pub. Date: Nov. 15, 2012

(54) AUTHENTICATED SECURITY SYSTEM

(75) Inventor: Eric V. Kline, Rochester, MN (US)

(73) Assignee: INTERNATIONAL BUSINESS MACHINES CORPORATION, Armonk, NY (US)

(21) Appl. No.: 13/107,774

(22) Filed: May 13, 2011

(51) Int. Cl. G06F 7/04

(52) U.S. Cl. 340/5.81

(57) ABSTRACT

An apparatus, system, and method are disclosed for detecting intruders within a home or business. The apparatus may include a signal generation module that generates a signal pulse. At least a portion of the signal pulse is reflected off individuals within the space. The signal pulse also includes instructions for an RFID tag to send a response message. A first distance is measured between the individual and a position sensor using the reflected portion of the signal. A second distance is measured between the RFID tag and the RFID reader. If the distances are substantially equal, the individual is treated as authorized to be in the space. If the distances are not equal, or if no response is received from the RFID tag, the individual is treated as unauthorized and security measures are taken.

### BACKGROUND

1. Field

The subject matter disclosed herein relates to security systems.

2. Description of the Related Art

Physical security in residences and businesses is an issue of great importance. Homes are vulnerable to theft and entry of unauthorized persons. Businesses and other spaces are similarly vulnerable. Unauthorized persons may steal valuable items or threaten harm to persons in the space. While security systems have been developed to help protect people and property, these security systems may provide incomplete or insufficient protection.

### BRIEF SUMMARY

From the foregoing discussion, it should be apparent that a need exists for an apparatus, method, and computer program product that increases security through authentication. In one embodiment, an apparatus may include a signal generation module, a position detection module, an RFID position module, and an authorization module.

The signal generation module may be configured to generate a signal pulse. At least a portion of the signal pulse that is incident upon an individual is reflected as a reflected portion. At least a portion of the signal pulse instructs a radio-frequency identification (“RFID”) tag to send a response message to an RFID reader.

The position module determines a first distance between the individual and the position sensor. The determination is made using the reflected portion of the signal pulse that is received at the position sensor.

The RFID position module determines a second distance between the RFID tag and the RFID reader if the RFID reader receives the response message.

The authorization module determines that the individual is unauthorized if the first distance and the second distance are outside an acceptable range of each other.

A system may include a signal generation module that generates the signal pulse with the portion that is reflected when incident upon an individual, and the portion that instructs an RFID tag to send a response message to an RFID reader. The system may also include a position sensor that receives the reflected portion of the signal pulse, and an RFID reader that receives the response message generated by the RFID tag. The system may also include a position detection module, an RFID position module, and an authorization module as described above.

A method may include the steps of generating a signal pulse that includes a position component that is reflected (the “reflected portion”) when the signal pulse is incident upon an individual, and an instruction component that instructs an RFID tag to send a response message. The method may also involve receiving the reflected portion and determining the first distance between the individual and the position sensor that receives the reflected portion. The method may also involve receiving the response message, and determining a second distance between the RFID tag and the RFID reader if the RFID reader receives the response message. The method may also involve determining that the individual is unauthorized if the first distance and the second distance are outside an acceptable range of each other.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a protected space with an authentication apparatus sending a signal pulse;

FIG. 2 is a schematic block diagram illustrating one embodiment of a protected space with an authentication apparatus receiving a reflected portion and a response message;

FIG. 3 is a schematic block diagram illustrating one example of a protected space with an authenticated individual and an un-authenticated individual, and the authentication apparatus sending a signal pulse;

FIG. 4 is a schematic block diagram illustrating one example of a protected space with an authenticated individual and an un-authenticated individual, and the authentication apparatus receiving reflected portions and a response message;

FIG. 5 is a schematic block diagram illustrating one example of a protected space with an authenticated individual and an un-authenticated individual, and the first distances and second distance;

FIG. 6 is a schematic block diagram illustrating one example of a protected space with an authenticated individual, an authentication apparatus, and multiple sensors;

FIG. 7 is a schematic block diagram illustrating one example of an authentication apparatus;

FIG. 8 is a schematic block diagram illustrating one example of a protected space with an authenticated individual, an authentication apparatus, and a motion sensor; and

FIG. 9 is a schematic flow chart diagram illustrating one embodiment of a method for authenticating a individual in a protected space.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the C programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

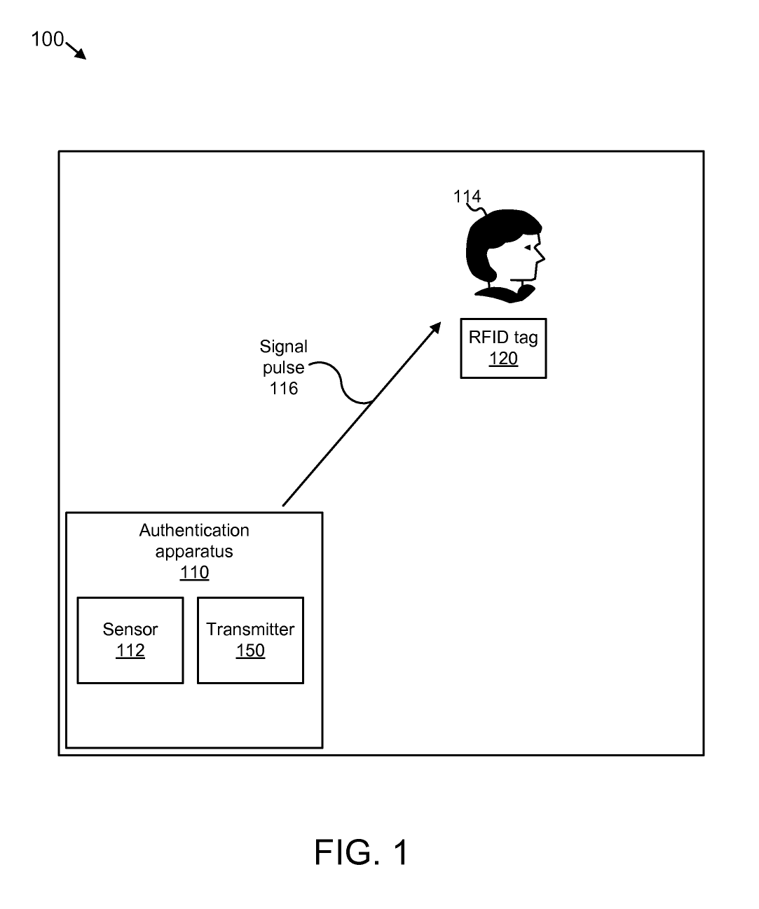

FIG. 1 depicts one embodiment of a protected space 100 with an authentication apparatus 110 and an individual 114. Protected space 100, as used in this application, refers to any three-dimensional expanse that requires access control. The protected space 100 may be a residence, a business space, a warehouse, an open area (such as a field or backyard), or other space that needs to be secured.

The individual 114 wears, or carries with her, a radio frequency identification (“RFID”) tag 120 (also known as RFID labels). The RFID tag 120 is a device that communicates information with an RFID reader (also known as RFID interrogators). The term RFID is used broadly in this application to encompass known RFID technology and Acoustic Frequency Identification (AFID) technology. The RFID tag 120 receives commands and messages and is capable of generating response messages that can be read and received by an RFID reader. The RFID tag 120, in various embodiments, may be passive, active, or battery assisted passive (“BAP”). Individuals 114 who are authorized to be in the protected space 110 are provided with an RFID tag 120 that they can keep on their person. The RFID tag 120 may be incorporated into a badge that clips onto clothing, a component that fits into a pocket, a component that can be permanently attached to clothing, or other device.

The authentication apparatus 110 provides access control for the protected space 100. The authentication apparatus 110 may, for example, ensure that individuals 114 are not permitted in the protected space 100 unless they have an RFID tag 120 on their person, or nearby. In certain embodiments, the authentication apparatus 110 may require that the RFID tag 120 be authorized; for example, the RFID tag 120 may store a unique alpha-numeric identifier. The authentication apparatus 110 may maintain a database of alpha-numeric identifiers for RFID tags 120 that are associated with authorized individuals 114. Even if the individual 114 has an RFID tag 120 within an acceptable distance from his body, the authentication apparatus 110 may determine that the individual 114 is not authorized unless the individual 114's RFID tag 120 has an alpha-numeric identifier that is found in the database of authorized alpha-numeric identifiers.

As seen in FIG. 1, the authentication apparatus 110 may be configured to generate a signal pulse 116. The signal pulse 116 may be an electromagnetic signal. At least a portion of the signal pulse 116 incident upon the individual 114 is reflected (referred to herein as the “reflected portion”). At least a portion of the signal pulse 116 instructs the RFID tag 120 to send a response message to an RFID reader. The signal pulse 116 may include various components; for example, the signal pulse 116 may include a power component that provides power to the RFID tag 120. In one embodiment, the signal pulse 116 is made of different frequencies. For example, an instruction component that instructs the RFID tag 120 to send a response message may have a first frequency, while a position component that is reflected back as the reflected portion may be at a second, different frequency. In other embodiments, the signal pulse 116 is sent at a single frequency.

In certain embodiments, at set up, the authentication apparatus 110 initially scans the protected space 100 during set up in order to determine what objects are in the protected space 100 and how the signal pulse 116 is reflected when no individuals 114 are in the protected space 100. This information may be stored in the authentication apparatus 110 and used to interpret reflections after a signal pulse 116 is sent. For example, deviations from the values that represent an empty protected space 100 may be interpreted as indicating that an individual 114 is present in the protected space 100.

The authentication apparatus 110 is shown including a sensor 112 and a transmitter 150. The transmitter 150 may be used to generate and emit the signal pulse 116. The sensor 112 may be configured to receive the reflected portion. The sensor 112 may be configured to receive a response message from the RFID tag 120. The sensor 112 and the transmitter 150 may be part of a single, physical device. In other embodiments, there are a plurality of transmitters 150 and a plurality of sensors 112 that are distributed throughout the protected space 100.

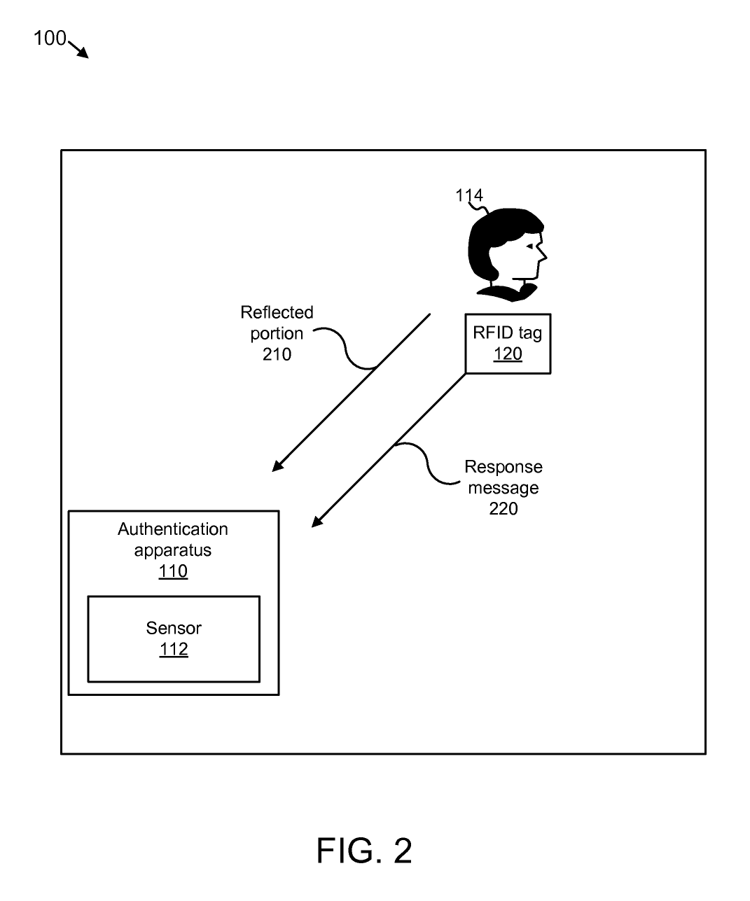

FIG. 2 shows an embodiment of the protected space 100 after the signal pulse 116 is incident upon the individual 114. As described above, at least a portion of the signal pulse 116 incident upon the individual 114 is reflected as the reflected portion 210. The RFID tag 120 generates the response message 220 when the RFID tag 120 receives the signal pulse 116.

The authentication apparatus 110 may include one or more sensors 112. For example, the sensors 112 may include a position sensor and an RFID reader. The position sensor responds to the reflected portion 210. The position sensor may be an infrared (IR) motion detector, an ultrasound motion detector, a microwave motion detector, or other variety of position sensor. The authentication apparatus 110 may determine the distance between the individual 114 and the position sensor (“the first distance”) using the reflected portion 210 of the signal pulse 116 that is received by the position sensor.

The authentication apparatus 110 may also determine the distance between the RFID tag 120 and the RFID reader (“the second distance”) if the RFID reader receives the response message 220. If the first distance and the second distance are outside of an acceptable range of each other, the authentication apparatus 110 may determine that the individual 114 is unauthorized and initiate security protocols. For example, the authentication apparatus 110 may sound an alarm, or send an alert to security personnel. The acceptable range may be user configurable. In one embodiment, the acceptable range is three feet.

If the individual 114 is wearing the RFID tag 120, the authentication apparatus 110 will note that there is no difference (or only a small difference) between the first distance between the individual 114 and the position sensor, and the second distance between the individual 114 and the RFID reader. As a result, the authentication apparatus 110 may determine that the individual 114 is authorized to be in the protected space 100. The authentication apparatus 110 may perform additional tests as well; for example, as noted above, the authentication apparatus 110 may determine whether the RFID tag 120 is an authorized RFID tag 120 that grants access to the protected space 100.

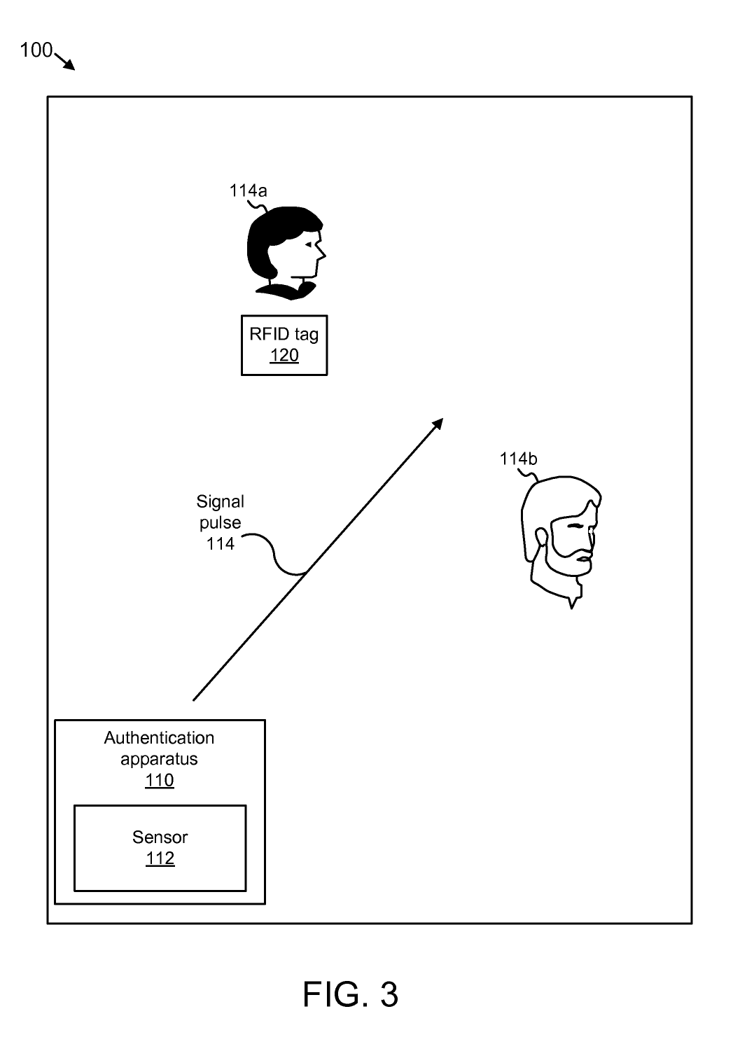

FIG. 3 shows a protected space 100 with an authorized individual 114a with an RFID tag 120, and an unauthorized individual 114b without an RFID tag 120. As above, the authentication apparatus 110 generates a signal pulse 116, a portion of which reflects when incident upon an individual 114a-b, and a portion of which provides instructions for an RFID tag 120. One signal pulse 116 may be sufficient to probe the entire protected space 100. In other embodiments, multiple signal pulses 114 (each having a position component and an instruction component) may be necessary to ensure adequate coverage of the entire protected space 100. In FIG. 3, the signal pulse 116 is sent into the protected space 100 with the authorized individual 114a and the unauthorized individual 114b.

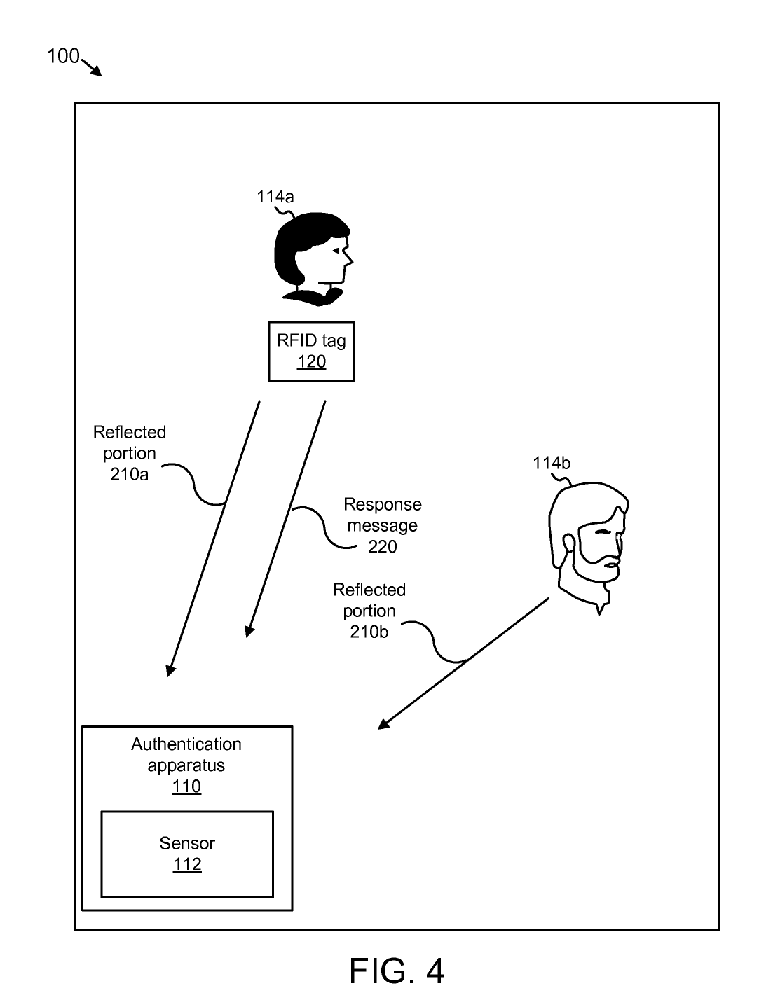

FIG. 4 shows the response to the signal pulse 116 in FIG. 3. A reflected portion 210a is reflected back to the sensor 112 from the individual 114a, while the reflected portion 210b is reflected back to the sensor 112 from the individual 114b. A response message 220 is generated by the RFID tag 120. In certain embodiments, the authentication apparatus 110 determines that an unauthorized individual 114b is present in the protected space 100 because the sensors 112 detected two reflected portions 210a-b, but only one response message 220. For example, one reflected portion 210a may be a different distance or different location than the other reflected portion 210b.

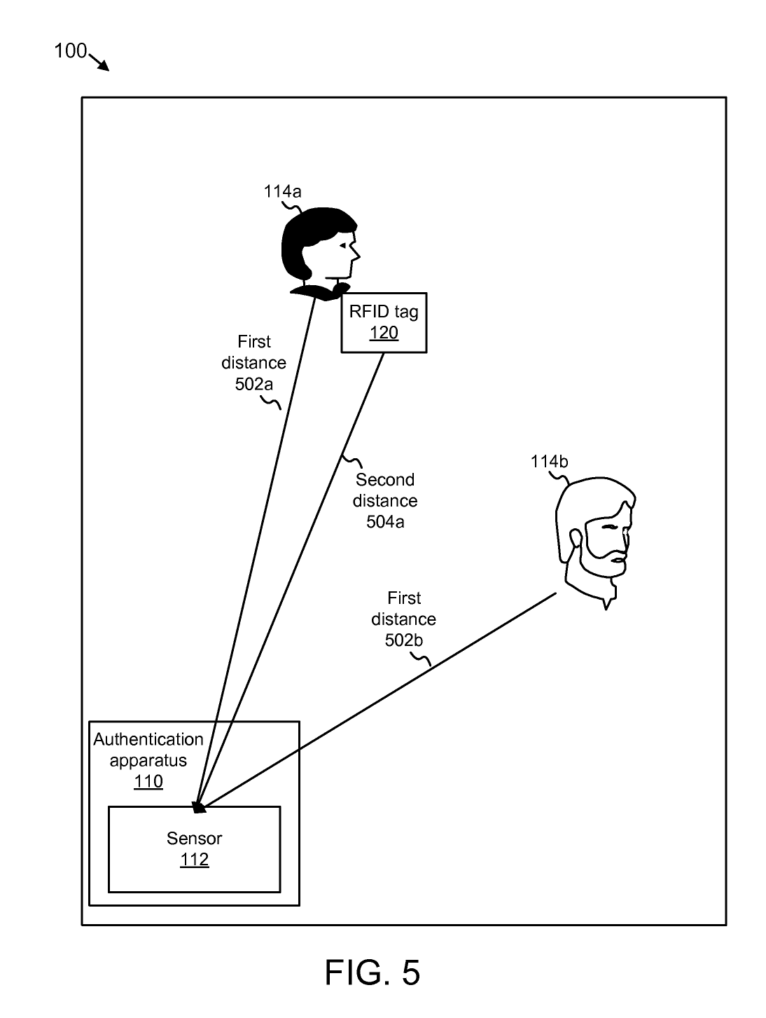

FIG. 5 shows the first distance 502a between the individual 114a and the sensor 112, the second distance 504a between the RFID tag 120 and the sensor 112, and the first distance 502b between the individual 114b and the sensor 112. The authentication apparatus 110 may determine that first distance 502a and the second distance 504a are within an acceptable range or each other. However, the separation between the first distance 502b and the second distance 504a may be outside the acceptable range. The authentication apparatus 110 may determine that the individual 114b is unauthorized and initiate security protocols since the first distance 502b and the second distance 504a are outside an acceptable range of each other for the individual 114b.

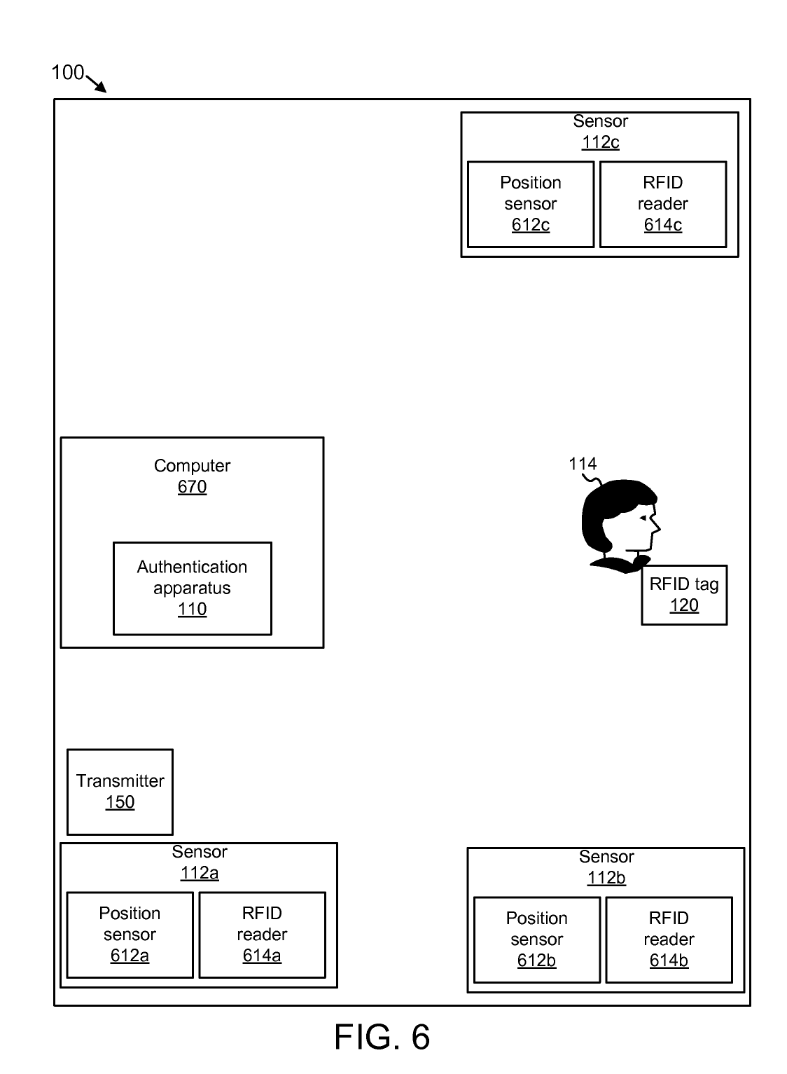

In FIG. 6, the protected space 100 includes a plurality of sensors 112a-b. As described above, the sensors 112a-b may include position sensors 612a-c and RFID readers 614a-c. In embodiments with a plurality of sensors 112a-c, the authentication apparatus 110 may triangulate a location of the individual 114, and a location of the RFID tag 120. The authentication apparatus 110 may determine that the individual 114 is authorized if the location of the individual 114 within the protected space 100 and the location of the RFID tag 120 are within an acceptable range of each other.

FIG. 6 also shows a computer 670 that comprises at least components of the authentication apparatus 110. The computer 670 may be a general purpose computer 670, or a specialized computer 670 designed for supporting the authentication apparatus 110 software components, and communicating with those components of the authentication apparatus 110 that may be distributed. The computer 670 may include a processor and memory for storing executable code for performing the operations of the authentication apparatus 110 described herein.

In certain embodiments, the authentication apparatus 110 communicates information with the sensors 112a-c and the transmitter 150. The computer 670 may be wirelessly connected to the sensors 112a-c and the transmitter 150. The computer 670 may have a physical connection to the sensors 112a-c and the transmitter 150 such as, for example, an Ethernet connection. The authentication apparatus 110 may cause the transmitter 150 to generate and send the signal pulse 116, and receive readings back from the sensors 112a-c. The computer 670 may be kept in a secure location of the protected space 100 where individuals 114 do not have access in order to reduce the possibility of unauthorized users 114 disabling or damaging the computer 670 that supports the authentication apparatus 110.

While FIG. 6 shows only one transmitter 150, in certain embodiments, a plurality of transmitters 150 are distributed within the protected space 100. In certain embodiments, the transmitters 150 are in communication with the authentication apparatus 110 and provide information to the authentication apparatus 110. Such information may include, for example, a time when the signal pulse 116 was generated and sent.

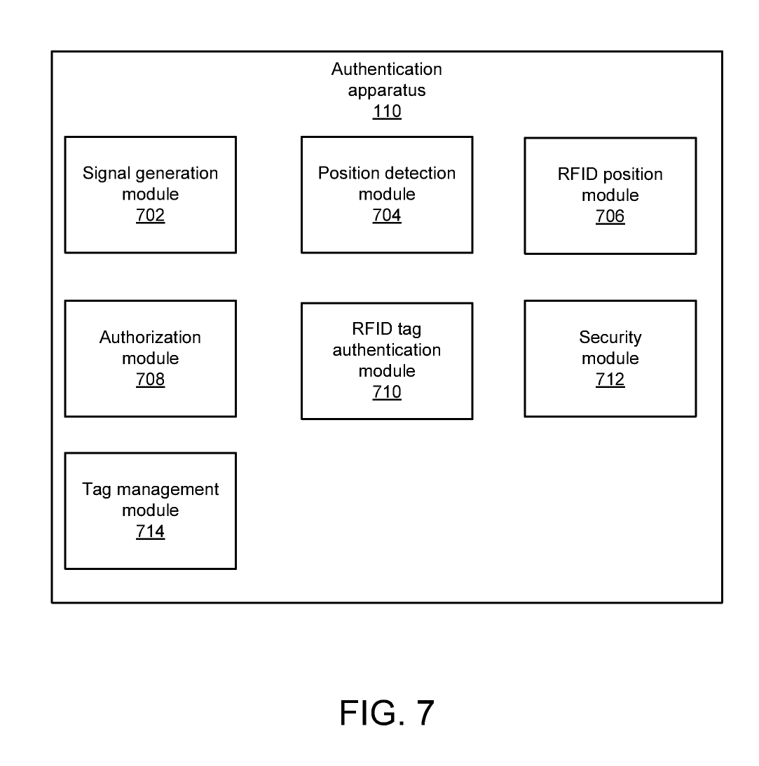

FIG. 7 shows one embodiment of the authentication apparatus 110. The authentication apparatus 110 may include a signal generation module 702 that generates the signal pulse 116. The signal pulse 116 so generated may have at least a portion that, when incident upon an individual, is reflected as a reflected portion 210. The signal pulse 116 may also include at least a portion that instructs the RFID tag 120 to send a response message to an RFID reader 614. Portions of the signal pulse 116 may be lost or absorbed by the individual and other objects within the protected space 100. In certain embodiments, the signal generation module generates the signal pulse 116 to authenticate an individual 114 only upon entry of the individual 114 into the protected space. In certain embodiments, a single signal performs both functions (determining the location of the individual within the protected space 100, and instruct the RFID tag 120 to send a response message).

The signal pulse 116 may have multiple components. One component may be used for determining position, while one component is used to provide instruction to the RFID tag 120. In one embodiment, the signal pulse 116 is a composite of two signals sent as a single pulse; the position component of the signal pulse 116 may have a frequency that is optimized for reflection, while the instruction component of the signal pulse 116 is optimized for absorption by the RFID tag 120. The signal pulse 116 may also include other components, such as a power component for powering the RFID tag 120. The instruction component of the signal pulse 116 may be embedded within the position component. In other embodiments, the instruction component is the first part of the signal pulse 116 that is transmitted, and the position component is the second part of the signal pulse 116 that is transmitted. In certain embodiments, the position component is the first part of the signal pulse 116 that is transmitted, and the signal component is the second part of the signal pulse 116 that is transmitted. Other approaches to transmitting a single signal pulse 116 that includes both an instruction component and a position component may also be used.

The authentication apparatus 110 may also include a position detection module 704. The position detection module 704 may be configured to determine the first distance 502, which is the distance between the individual 114 and a position sensor 612. The position detection module 704 may determine the first distance 502 using the reflected portion 210 of the signal pulse 116. The reflected portion 210 is received at the position sensor 210. The position detection module 704 may include the position sensor 612. In certain embodiments, multiple position sensors 612 are disposed throughout the protected space 100. The position detection module 704 may be configured to triangulate the location of the individual 114 in the protected space 100 using the distance readings from the various position sensors 612. Thus, in certain embodiments, the position detection module 704 may determine only a one first distance 502; in other embodiments, the position detection module 704 may determine more than one first distance 502, and determine a location from the plurality of first distances 502.

In one embodiment, the position detection module 704 determines the first distance based on the difference between the time the signal generation module 702 sends the signal pulse 116, and the time the position sensor 612 receives the reflected portion 210. For example, for a signal pulse 116 with a known speed, the position detection module 704 may determine the time that the signal pulse 116 was sent, and the time that the reflected portion 210 was received, and derive the total distance traveled during that time. The position detection module 704 may then half that distance to arrive at the first distance 502.

The authentication apparatus 110 may also include an RFID position module 706 that determines a second distance 504, which is the distance between the RFID tag 120 and the RFID reader 614. The RFID position module 706 may determine the second distance 504 using the response message 220 if the RFID reader 614 receives a response message 220. In certain embodiments, multiple RFID readers 614 are disposed throughout the protected space 100, and the RFID position module 706 triangulates the location of the RFID tag 120 in the protected space 100 using the distance readings from the various RFID readers 614.

In one embodiment, the RFID position module 706 determines the second distance 504 based on the difference between the time the signal generation module 702 sends the signal pulse 116, and the time the RFID reader 614 receives the response message 220. For example, for a signal pulse 116 with a known speed, the RFID position module 706 may determine the time that the signal pulse 116 was sent, and the time that the response message 220 was received. The RFID position module 706 may also account for the time necessary for the RFID tag 120 to receive, process, and respond to the signal pulse 116. The RFID position module 706 may determine the difference between the time the signal pulse 116 was sent and the time the response message 220 was received. The RFID position module 706 may subtract from that time the time necessary for the RFID tag 120 to process and respond to the signal pulse 116. The RFID position module 706 may assume a certain speed for the signal pulse 116, and a speed for the response message 220. In this manner, the RFID position module 706 may derive a sufficiently accurate approximation of the total distance traveled by the signal pulse 116, and the second distance 504.

The authentication apparatus 110 may also include an RFID tag authentication module 710. The RFID tag authentication module 710 may be configured to determine whether the RFID tag 120 is an authorized RFID tag 120. As discussed above, the RFID tag authentication module 710 may maintain a data structure (such as a list, file, database, etc) of identifiers for RFID tags 120 that are authorized. The response message 220 may contain the identifier, which is compared by the RFID tag authentication module 710 with the data structure of authorized identifiers.

The authentication apparatus 110 may also include an authorization module 708. The authorization module 708 may be configured to determine that the individual 114 is unauthorized if the first distance 502 and the second distance 504 are outside an acceptable range of each other. In one embodiment, the acceptable range is a default value such as 3 feet. In other embodiments, the acceptable range is a user-configurable parameter. The acceptable range is preferably set at a value that allows for differences between the first distance 502 and the second distance 504 that may result from uncertainty inherent in distance calculations based on assumptions.

The authorization module 708 may determine that the individual 114 is authorized if the first distance 502 and the second distance 504 are within the acceptable range. The authorization module 708 may further require that the RFID tag authentication module 710 determine that the RFID tag 120 is an authorized RFID tag 120 before determining that the individual 114 is authorized. Thus, in certain embodiments, both conditions must be met before the individual 114 is determined to be authorized.

In certain embodiments, if the position detection module 704 detects a person in the protected space 100 and determines the first distance 502, but the RFID reader 614 does not receive a response message 220, the authorization module 708 determines that an individual 114 is in the protected space 100 and that the individual 114 is unauthorized. The authorization module 708 may similarly determine that an unauthorized person 114 is in the protected space 100 if the number of persons detected by the position detection module 704 is not equal to the number of response messages 220 received by the RFID reader 614.

In certain embodiments, the authorization module 708 makes a determination that an unauthorized individual 114 is in the protected space 100 using multiple readings. For example, the signal generation module 702 may generate signal pulses 114 at regular intervals. The authorization module 708 may require that the first distance 502 and the second distance 504 be determined to be outside the acceptable range multiple times (based on multiple signal pulses 114) before determining that the individual 114 is unauthorized. The authorization module 708 may similarly require multiple readings of other events that would indicate an individual 114 in the protected space 100 is unauthorized (such as those described above) before determining that the individual 114 is unauthorized. Using multiple readings may help prevent false identifications of unauthorized individuals 114.

The authentication apparatus 110 may also include a security module 712 that initiates one or more security protocols in response to the authorization module 708 determining that an individual 114 in the protected space 100 is unauthorized. The security protocols may include sounding an alarm, notifying security, notifying police, or other appropriate security actions. The security module 712 may combine one or more of these actions as part of the security protocol. In certain embodiments, the severity of the action increases over time. For example, the security module 712 may first prompt an individual 114 to enter a security code at a panel if the authorization module 708 determines that the individual 114 is unauthorized. If the individual 114 fails to enter the security code within a set time frame, the security module 712 may sound an alarm. If the individual 114 fails to enter the security code within a longer time period, the security module 712 may alert the police.

The authentication apparatus 110 may also include a tag management module 714 for managing the RFID tags 120. The tag management module 714 may allow a user to indicate which RFID tags 120 are authorized by pairing an RFID tag 120 with the security system that includes the authentication apparatus 110.

In certain embodiments, the tag management module 714 allows for permanent tags and for guest tags. A guest tag may be an RFID tag 120 that is temporarily authorized. In certain embodiments, the authorization of the guest tag expires after a predetermined period of time. For example, a user may authorize a guest tag for a four hour period. The RFID tag authentication module 710 may store the identifier associated with the guest tag for four hours, and after that time, remove the identifier from the data structure containing the identifiers for authorized RFID tags 120. Thus, after four hours, a person wearing the guest tag will no longer be considered authorized since the identifier for the guest tag will no longer be treated as valid by the RFID tag authentication module 710.

In certain embodiments, the authorization of the guest tag is limited to particular areas within the protected space 100; for example, the guest tag may be treated as authorized by the RFID tag authentication module 710 in common areas or a conference room, but will be treated as unauthorized by the RFID tag authentication module 710 in a laboratory or a storage room in the protected space 100.

The tag management module 714 may be further used to add and remove RFID tags 120 from the list of authorized RFID tags 120. The tag management module 714 may allow an administrator to add new RFID tags 120, and remove old ones that are broken, lost, stolen, or that otherwise need to be removed. The tag management module 714 may further allow the administrator to set specific permissions for each RFID tag 120 that indicate which areas an individual 114 with the RFID tag 120 is allowed to access. The tag management module 714 may also specify times when an individual 114 with the RFID tag 120 is allowed to access a particular area of the protected space 100. The tag management module 714 may be used to implement other rules as well.

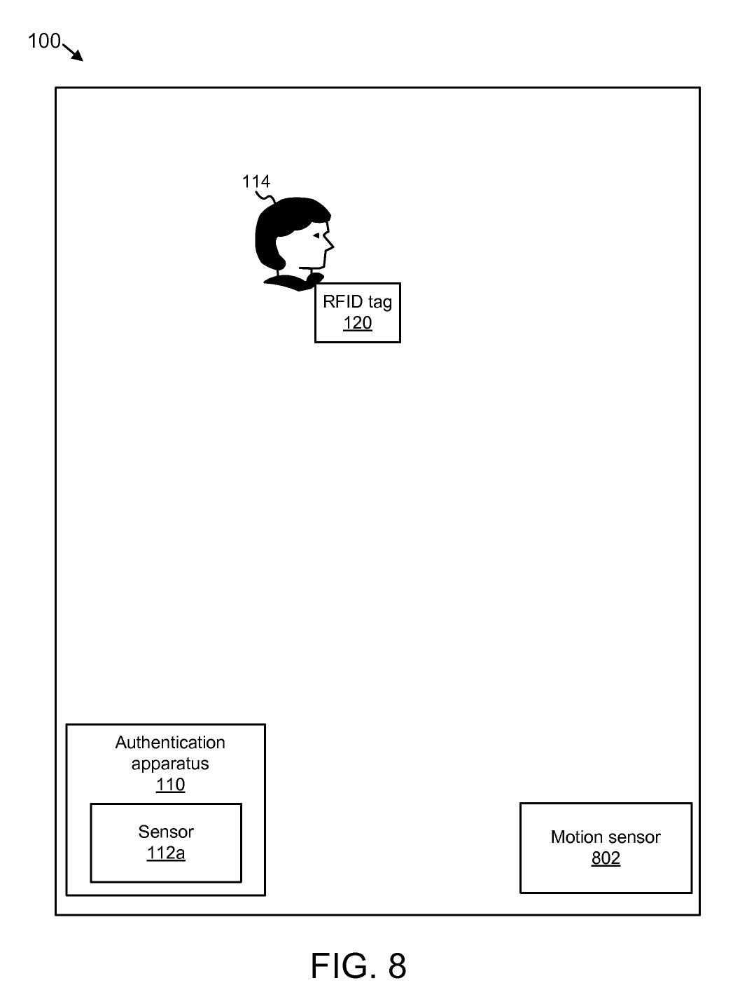

FIG. 8 shows another embodiment of a protected space 100 with an individual 114 with an RFID tag 120, an authentication apparatus 110, and a motion sensor 802. In certain embodiments, the authentication apparatus 110 generates the signal pulse 116 to authenticate the individual only upon entry of the individual 114 into the protected space 100. For example, the authentication apparatus 110 may authenticate the individual 114 as the individual 114 comes through a door. Furthermore, the individual 114 in such an embodiment may not need the RFID tag 120. The individual 114 may authenticate herself by entering a code on a keypad at the entrance. Other forms of authentication may also be used to perform the authentication function.

The motion sensor 802 may be used to track the individual 114 in the protected space 100 after authentication. In one embodiment, the motion sensor 802 may be a camera coupled to a computer with software for tracking the movement of individuals in the protected space 100 that is monitored by the motion sensor 802. Other varieties of motion sensors 802 that can track an individual 114 may also be used. Once the individual 114 is authenticated, the motion sensor 802 may track that individual's movement rather than require the authentication apparatus 110 to continuously send signal pulses 114 or otherwise continuously authenticate the individual 114. As noted above, in certain embodiments, other forms of authentication are used other than sending signal pulses 114.

In certain embodiments, if the motion sensor 802 detects an individual 114 in the protected space 100 other than the individual 114 who has been authenticated, the security module 712 of the authentication apparatus 110 initiates one or more security protocols. The motion sensor 802 may send a message to the authentication apparatus 110 indicating the presence of an individual 114 in the protected space other than the authorized individual 114. The authentication apparatus 110 may, in response, attempt to re-authenticate the individual 114 as well as any other individual 114 in the protected space 100.

The authentication apparatus 110 may re-authenticate the individual 114 each time the individual 114 moves outside the scope of the motion sensor 802. For example, where the motion sensor 802 is a camera monitoring one room in the protected space 100, the authentication apparatus 110 may re-authenticate the individual 114 when the individual 114 enters a different room that is not monitored by the motion sensor 802. The different room may include its own motion sensor 802, which may track the motion of the individual 114 through that room once the individual 114 is authenticated.

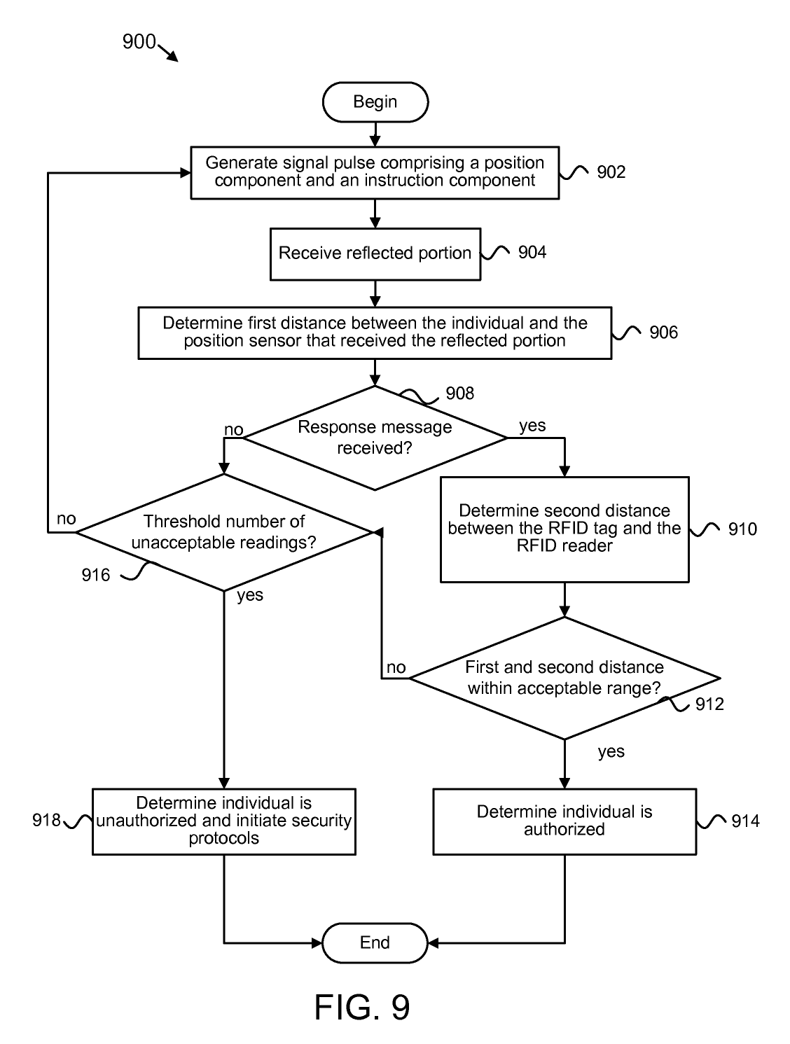

FIG. 9 shows one embodiment of a method 900 for authenticated individuals 114 in a protected space 100. The method 900 may begin with generating 902 a signal pulse 116 comprising a position component that is reflected back as a reflected portion 210 when the signal pulse 116 is incident upon an individual 114. The signal pulse 116 may also include an instruction component that instructs an RFID tag 120 to send a response message 220.

The method 900 may also involve receiving 904 a reflected portion 210 that is reflected when incident upon the individual 114. The method 900 may include determining 906 the first distance 502 between the individual 114 and the position sensors 612 (whether one or many) that received the reflected portion 210.

The method 900 may further include determining 908 whether a response message 220 from an RFID tag 120 is received by an RFID reader 614. If the response message 220 is not received, the method 900 may involve determining 916 whether a threshold number of unacceptable readings has been reached. An unacceptable reading may be, for example, a failure to receive a response message 220, the first distance 502 and the second distance 504 being outside an acceptable range of each other, or other readings that would indicate that the individual 114 is unauthorized. A number stored in memory indicating the number of unacceptable readings may be incremented if a response message 220 is not received. If the threshold number has not been reached, the method 900 may continue by generating 902 signal pulses and moving through the process shown in FIG. 9 until either a response message 220 is received, or the threshold number of unacceptable readings has been reached, at which point the authentication apparatus 110 may determine 918 that the individual is unauthorized and initiate security protocols. Such an embodiment protects against false initiations of security protocols caused by an RFID tag 120 failing to successfully respond due to, for example, interference, weak signal, and other possible causes of failure.

If the response message 220 is received, the method 900 may involve determining 910 the second distance 504 between the RFID tag 120 and the RFID reader 614 that received the response message 220. The method 900 may further involve determining 912 whether the first distance 502 and the second distance 504 are within an acceptable range of each other. If the first distance 502 and the second distance 504 are not within an acceptable range of each other, the method 900 may involve incrementing the number of unacceptable readings and determining 916 whether a threshold number of unacceptable readings have been reached.

If the first distance 502 and second distance 504 are within an acceptable range of one another, the method 900 may involve determining 914 that the individual is authorized. The method 900 may also involve resetting the number of unacceptable readings to zero. As noted above, the method 900 may also involve determining whether the RFID tag 120 that generated the response message 220 is an authorized RFID tag 120 as part of determining whether the individual 114 is authorized.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes,” “has,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a signal generation module configured to generate a signal pulse, wherein:
at least a portion of the signal pulse incident upon an individual is reflected as a reflected portion; and
at least a portion of the signal pulse instructs a radio frequency identification (“RFID”) tag to send a response message to an RFID reader;
a position detection module configured to determine a first distance between the individual and a position sensor using the reflected portion of the signal pulse received at the position sensor;
an RFID position module configured to determine a second distance between the RFID tag and the RFID reader in response to the RFID reader receiving the response message; and
an authorization module configured to determine that the individual is unauthorized in response to the first distance and the second distance being outside an acceptable range of each other.

2. The apparatus of claim 1, further comprising an RFID tag authentication module configured to determine whether the RFID tag is an authorized RFID tag.

3. The apparatus of claim 2, wherein the authorization module is further configured to determine that the individual is authorized in response to:
the first distance and the second distance being within the acceptable range; and
the RFID tag being an authorized RFID tag.

4. The apparatus of claim 1, wherein the authorization module determines that the individual is unauthorized in response to determining that a plurality of first distances and second distances are outside the acceptable range.

5. The apparatus of claim 1, wherein the authorization module determines that the individual is unauthorized in response to the position detection module determining the first distance, and the RFID position module not receiving the response message.

6. The apparatus of claim 1, further comprising a security module configured to initiate one or more security protocols in response to the authorization module determining that the individual is unauthorized.

7. The apparatus of claim 1, wherein the signal generation module generates the signal pulse to authenticate the individual only upon entry of the individual into a protected space.

8. The apparatus of claim 7, further comprising a motion sensor module that tracks the individual in the protected space after authentication.

9. The apparatus of claim 8, further comprising a security module configured to initiate one or more security protocols in response to the motion sensor module detecting an unauthorized individual in the protected space.

10. The apparatus of claim 1, further comprising a plurality of position sensors and RFID readers.

11. The apparatus of claim 10, wherein the position detection module is further configured to triangulate a location of the individual, and wherein the RFID position module is further configured to triangulate a location of the RFID tag.

12. The apparatus of claim 11, wherein the authentication module is further configured to determine that the individual is unauthorized in response to the location of the individual and the location of the RFID tag being outside the acceptable range.

13. A system comprising:
a signal generation module configured to generate a signal pulse, wherein:
at least a portion of the signal pulse incident upon an individual is reflected as a reflected portion; and
at least a portion of the signal pulse instructs a radio frequency identification (“RFID”) tag to send a response message to an RFID reader;
a position sensor configured to receive the reflected portion of the signal pulse;
the RFID reader configured to receive the response message;
a position detection module configured to determine a first distance between the individual and the position sensor using the reflected portion of the signal pulse received at the position sensor;
an RFID position module configured to determine a second distance between the RFID tag and the RFID reader in response to the RFID reader receiving the response message; and
an authorization module configured to determine that the individual is unauthorized in response to the first distance and the second distance being outside an acceptable range of each other.

14. The system of claim 13, wherein the position sensor is one of an infrared (“IR”) motion detector, an ultrasound motion detector, and a microwave motion detector.

15. The system of claim 13, further comprising a tag management module that authorizes the RFID tag when the RFID tag is issued.

16. The system of claim 15, wherein the tag management module deauthorizes the RFID tag in response to expiration of a timer.

17. The system of claim 15, further comprising an RFID tag authentication module configured to determine whether the RFID tag is an authorized RFID tag.

18. The system of claim 17, wherein the authorization module is further configured to determine that the individual is authorized in response to:
the first distance and the second distance being within the acceptable range; and
the RFID tag being an authorized RFID tag.

19. A method comprising:
generating a signal pulse comprising:
a position component that is reflected as a reflected portion when the signal pulse is incident upon an individual; and
an instruction component that instructs a radio frequency identification (“RFID”) tag to send a response message;
receiving the reflected portion;
determining a first distance between the individual and a position sensor that received the reflected portion of the signal pulse;
receiving the response message;
determining a second distance between the RFID tag and an RFID reader in response to the RFID reader receiving the response message; and
determining that the individual is unauthorized in response to the first distance and the second distance being outside an acceptable range of each other.

20. The method of claim 19, further comprising determining whether the RFID tag is an authorized RFID tag.
